(19) United States
(12) Patent Application Publication
(10) Pub. No.: US 2006/0140169 A1
(43) Pub. Date: Jun. 29, 2006

(54) Inter set top box personal messaging without using internet

(76) Inventor: Aravind Soundararajan, Chennai (IN)

Correspondence Address: PHILIPS INTELLECTUAL PROPERTY & STANDARDS, P.O. BOX 3001, BRIARCLIFF MANOR, NY, 10510, US

(21) Appl. No.: 10/537,890

(22) PCT Filed: Dec. 12, 2003
(86) PCT No.: PCT/IB03/05911

§ 371 Date: Jun. 7, 2005

Related U.S. Application Data
(60) Provisional application No. 60/433,746, filed on Dec. 16, 2002.

(51) Int. Cl. H04L 12/66

(52) U.S. Cl. 370/352; 379/90.01

(57) ABSTRACT

A communication method which allows users to send and received text messages between their respective set top boxes. The method which includes transmitting text messages from multiple source set top boxes to an exchange. The exchange, in turn, packetizes the text messages into data packets and forwards the data packets to a multiplexor. The multiplexor multiplexes the data packets along with audio and video data into an output transport stream. The output transport stream is then broadcast to multiple destination set top boxes. The destination set top boxes have demultiplexing capability, thereby allowing a user at the destination set top box to ultimately read, and respond, to the original transmitted text message. A system employing the same is further disclosed.

This invention relates generally to the field of personal messaging, and specifically, with a way to communicate between set top boxes without using the Internet.

Currently, people communicate through the Internet and/or over telephone lines via instant messaging, or delayed messaging like email.

Accordingly, there is a need in the field of electronic personal messaging for an improved system and method for communicating without the Internet.

The present invention provides an system and method for personal messaging without the Internet.

A first general aspect of the invention provides a method of communicating comprising:

transmitting a text message from a source set top box to an exchange.

A second general aspect of the invention provides a method of communicating comprising:

receiving a text message from a source set top box;

packetizing said text message into a plurality of data packets, wherein said plurality of data packets include said text message, an identifier of a destination set top box, an identifier of said source set top box, and a packet header information; and

forwarding said plurality of data packets to a multiplexor.

A third general aspect of the invention provides a method of communicating comprising:

receiving a plurality of text messages, wherein said plurality of text messages originated at a plurality of source set top boxes;

packetizing said plurality of text messages into a plurality of data packets;

multiplexing said plurality of data packets and audio data and video data into an output transport stream; and

broadcasting said output transport stream to a plurality of destination set top boxes.

A fourth general aspect of the invention provides a method of communicating comprising:

receiving a broadcasted, output transport stream including a plurality of data packets on a destination set top box;

demultiplexing said broadcasted, output transport stream at said destination set top box into a text message, wherein said text message originated on a source set top box.

A fifth general aspect of the invention provides a system for communicating comprising:

a service station adapted to receive a plurality of text messages sent from a plurality of source set top boxes, wherein said service station packets said plurality of text messages into a plurality of data packets;

a multiplexor in communication with said service station adapted to multiplex said plurality of data packets and audio data and video data into an output transport stream; and

broadcasting means for broadcasting said output transport stream to a plurality of destination set top boxes.

A sixth general aspect of the invention provides a communication system comprising:

transmitting means for transmitting a text message from a source set top box to a packetizing means;

packetizing means for packetizing said text message into a plurality of data packets, wherein said plurality of data packets include said text message, an identifier of said source set top box, and identifier of a destination set top box, and a packet header information;

multiplexing means in communication with said packetizing means for multiplexing said plurality of data packets and audio data and video data into an output transport stream; and

broadcasting means in communication with said multiplexing means for broadcasting said output transport stream to a destination set top box.

The foregoing and other features of the invention will be apparent from the following more particular description of various embodiments of the invention.

Some of the embodiments of this invention will be described in detail, with reference to the following figures, wherein like designations denote like members, wherein:

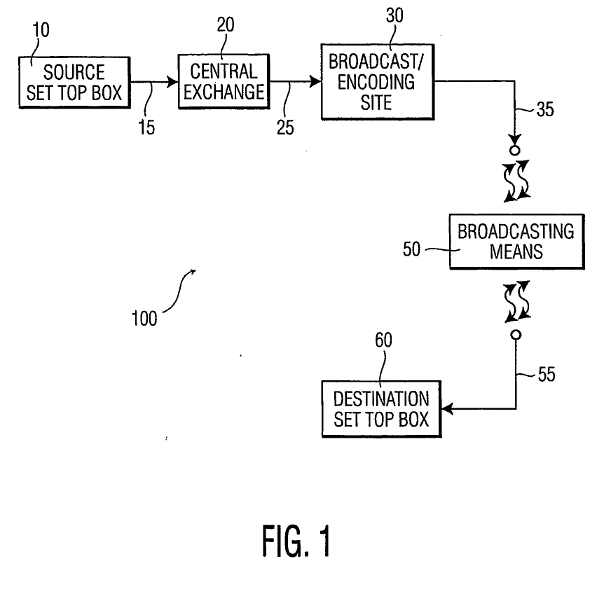

FIG. 1 depicts a schematic view of a system, in accordance with an embodiment of the present invention; and

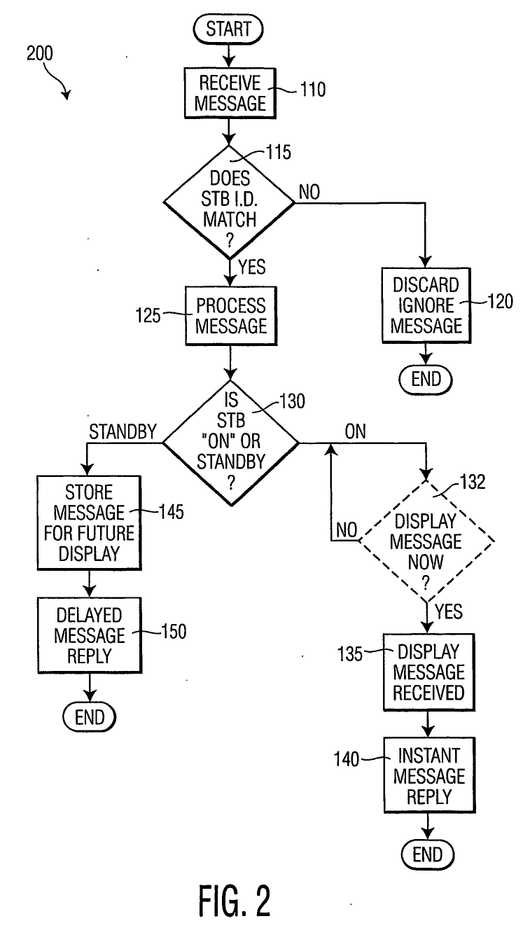

FIG. 2 depicts a flow chart of a portion of a system, in accordance with an embodiment of the present invention.

Although certain embodiments of the present invention will be shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc., and are disclosed simply as an example of an embodiment. Although the drawings are intended to illustrate the present invention, the drawings are not necessarily drawn to scale.

The present invention allows for personal messaging between at least two people, or entities, via their respective set top boxes. This method, and system, for communication may use private data packets, such as MPEG-2 (i.e., Moving Picture Experts Group) data packets, to deliver text messages to different set top boxes without the use of the Internet.

As FIG. 1 shows an embodiment of a system of the present invention. The communications system 100 comprises various devices including a plurality of set top boxes 10, 60. An originating, or source, set top box is at 10, while a receiving, or destination set top box is at 60. A set top box 10, 60 nominally sits on top of a television set in a home, office, etc.; hence, the term “set top box”. A set top box 10, 60 is any electronic device designed to produce output on a conventional television set and connected to some other communications channels such as telephone, ISDN, optical fiber, cable, satellite, wireless, etc. A set top box 10, 60 typically runs software that allows a user to interact with the programs shown on the television in some way. Thus, set top boxes 10, 60 are frequently employed to allow a user to watch subscription TV programs (e.g., Pay-per-View, Direct TVÔ, etc.). A set top box 10, when receiving messages, will employ forward channels to receive audio and video data, which are utilized when the user watches movies or television programs, and message data when receiving text messages, via the present invention. The set top box 60, in turn, employs back channels when sending return text messages. While FIG. 1 depicts two set top boxes 10, 60 by way of example, the communication system 100 may have several, if not thousands of, set top boxes 10, 60 all configured so as to communicate via this invention with each other. Thus, a user at one set top box 10 is able to communicate (e.g., send text messages) to a user at another set top box 60. In turn, the user at the second set top box 60 is able to communicate (e.g., receive and reply to the text message) back to the first set top box 10 user.

The originating, or source, set top box 10 is connected via a transmission means 15 to a central exchange 20, or similar structure. The transmission means 15 may be via telephone, cable, of some other suitable transmission means 15. The central exchange 20, or service station, will, inter alia, packetize data and forward the packeted data to a broadcast station, or encoding site 30. The packeting of the data by the central exchange 20 includes combining the text messages from several users of source set top boxes 10 and creating private data packets which comprise an identifier of the source set top box 10 (i.e., “Source I.D.”) which is mapped to a user I.D. of the source (i.e., sending) user, an identifier of the destination set top box 60 (i.e., “Destination I.D.”) which is mapped to a user I.D. of the destination (i.e., receiving) user, the text message, and some miscellaneous information. The miscellaneous information includes number of users, length of each data element, a loop, etc. To this, or “on top of”, aforementioned packeted data is added a packet header. In an embodiment, the packet header may be a MPEG-2 header. The MPEG-2 header would include, inter alia, a Reserve Program I.D. information. Ultimately, the central exchange 20 will combine the various text messages from multiple users and the other aforementioned information and packet them into data packets (e.g., MPEG-2 private data packets). These MPEG-2 private data packets are then forwarded 25 to a broadcast station, or encoding site 30.

The broadcast station, or encoding site 30 includes a multiplexing capability. The broadcast station 30, inter alia, encodes the MPEG-2 private data stream (i.e., Source I.D., Destination I.D., text message, miscellaneous information, and packet header) into a transport multiplex, or output transport stream. This step includes multiplexing of video data, audio data, and the aforementioned MPEG-2 private data. The private data includes a reserved program identifier (i.e. “Reserved P.I.D.”). Thus, the output transport stream including a Reserved P.I.D. is transmitted, or broadcast 35 to a broadcasting means 50. The broadcasting means 50 can be via numerous technologies including, but not limited to, satellite, cable TV, and wireless (e.g., Local Area Network) technologies. In an alternative embodiment the central exchange 20 functions and the broadcast station 30 functions may be combined in one locale.

Thus, a user situated at, near, or in communication with a source set top box 10 will dictate a text message to the set top box 10. This can be done by typing the text message with an actual keyboard (not shown) connected to the set top box 10 or by using a television remote control (not shown) connected electronically to a virtual keyboard (not shown) depicted on the television screen. In either embodiment, aside from creating the text message, the user also enters an identifier to which the text message is to be sent This identifier could be an email user I.D., or other identifier that is associated with the destination set top box 60 and/or recipient (i.e., receiving user). Ultimately, this identifier is, or is translated to, the Destination I.D.

Just as there can be a plurality of originating, or source, set top boxes 10, there can be a plurality of receiving, or destination set top boxes 60. Certainly, a source set top box 10 is not precluded form being additionally a destination set top box 60; and, vice versa. Indeed, typically a given set top box 10, 60 will be capable of both originating text messages as well as receiving text messages.

Thus, after the messages are ultimately multiplexed and transmitted, via the broadcasting means 50, into the transport stream 35, the various destination set top boxes 60 will be tuned so as to receive 55 the message I.D. in step 110. As the flow chart 200 in FIG. 2 shows, after a given set top box 60 receives a message, in step 110, the set top box 60, which includes a demultiplexing capability, checks to verify if the particular Reserve P.I.D. of the transmitted message matches, in step 115, the identifier of the destination set top box 60. Thus, after demultiplexing the output transport stream, the set top box 60 looks for the MPEG-2 header, or similar information. If the destination I.D. within the Reserve P.I.D. does not match the identifier of the destination set top box 60, then the message is ignored and discarded in step 120. Should, however, a match be found the destination set top box 60 will process the message in step 125.

A set top box 10, 60 can be either on, or in a standby mode. Thus, depending on whether the set top box 60 is on or in standby mode, different subsequent steps follow (see FIG. 2). Step 130 determines whether the set top box 60 is on or in the standby mode. If the destination set top box 60 is in the on mode, and the aforementioned codes match, then the destination set top box 60 will display the received message in step 135 on the television screen of the destination set top box 60 instantly. In an alternative embodiment, the destination set top box 60 can instead query the user at the destination set top box 60 if the user wants the message displayed, in optional step 132. The user can then answer yes, or no. A typical message on the television screen could query: “You have received a message from ‘John Doe’. Do you want the message displayed?” Should the user answer the query in the negative, the message is stored until later opting to display. Conversely, if the user answers in the affirmative, the message is displayed. In either embodiment, the user may respond back to the source set top box 10 user instantaneously in step 140. If the destination set top box 60 is set to “standby” mode, the transmitted message is stored for future display in step 145. Thus, the user is able to reply with a delayed message in step 150.

While this invention has been described in conjunction with the specific embodiments outlined above, it is evident that many alternatives, modifications and variations will be apparent to those skilled in the art. Accordingly, the embodiments of the invention as set forth above are intended to be illustrative, not limiting. Various changes may be made without departing from the spirit and scope of the invention as defined in the following claims.

1. A method of communicating comprising:
transmitting a text message from a source set top box to an exchange.

2. The method of claim 1, further comprising:
packetizing at the exchange said text message into a plurality of data packets, wherein said plurality of data packets include said text message, an identifier of said source set top box, an identifier of a destination set top box, and a packet header information; and
forwarding said plurality of data packets to a multiplexor.

3. The method of claim 2, further comprising:
multiplexing said plurality of data packets and audio data and video data into an output transport stream; and
broadcasting said output transport stream to the destination set top box.

4. The method of claim 2, wherein said plurality of data packets are in MPEG-2 format.

5. The method of claim 3, further comprising:
receiving said broadcasted, output transport stream at said destination set top box.

6. The method of claim 1, wherein said transmitting is done via telephone or cable.

7. The method of claim 3, wherein said broadcasting is done via satellite, cable, or wireless.

8. The method of claim 5, wherein said receiving is done via satellite, cable, or wireless.

9. The method of claim 4, further comprising:
demultiplexing said broadcasted, output transport stream at said destination set top box into said text message.

10. A method of communicating comprising:
receiving a text message from a source set top box;
packetizing said text message into a plurality of data packets, wherein said plurality of data packets include said text message, an identifier of a destination set top box, an identifier of said source set top box, and a packet header information; and
forwarding said plurality of data packets to a multiplexor.

11. The method of claim 10, wherein said plurality of data packets are packetized into a MPEG-2 format.

12. The method of claim 10, wherein said receiving is via telephone.

13. The method of claim 10, wherein said receiving is via cable.

14. A method of communicating comprising:
receiving a plurality of text messages, wherein said plurality of text messages originated at a plurality of source set top boxes;
packetizing said plurality of text messages into a plurality of data packets;
multiplexing said plurality of data packets and audio data and video data into an output transport stream; and
broadcasting said output transport stream to a plurality of destination set top boxes.

15. The method of claim 14, wherein said plurality of text messages are received via telephone or cable.

16. The method claim 14, wherein said broadcasting is via satellite, wireless, or cable.

17. The method of claim 14, further comprising:
demultiplexing said broadcasted, output transport stream at said plurality of destination set top boxes into said plurality of text messages.

18. A method of communicating comprising:
receiving a broadcasted, output transport stream including a plurality of data packets on a destination set top box;
demultiplexing said broadcasted, output transport stream at said destination set top box into a text message, wherein said text message originated on a source, set top box.

19. The method of claim 18, wherein said receiving is via satellite, cable, or wireless.

20. A system for communicating comprising:
a service station adapted to receive a plurality of text messages sent from a plurality of source set top boxes, wherein said service station packetizes said plurality of text messages into a plurality of data packets;
a multiplexor in communication with said service station adapted to multiplex said plurality of data packets and audio data and video data into an output transport stream; and
broadcasting means for broadcasting said output transport stream to a plurality of destination set top boxes.

21. The system of claim 20, wherein said broadcasting means is a satellite.

22. The system of claim 20, wherein said broadcasting means is cable.

23. The system of claim 20, wherein said broadcasting means is wireless means.

24. The system of claim 20, wherein said plurality of text messages received by said service station sent from said plurality of source set top boxes are received via telephone or cable.

25. The system of claim 20, further comprising:
a source set top box connected via communication means with said service station.

26. The system of claim 25, wherein said communication means is telephone or cable.

27. The system of claim 20, further comprising:
a destination set top box in communication with said broadcasting means.

28. The system of claim 27, wherein said destination set top box is in communication via satellite, cable, or wireless.

29. A communication system comprising:
transmitting means for transmitting a text message from a source set top box to a packetizing means;
packetizing means for packetizing said text message into a plurality of data packets, wherein said plurality of data packets include said text message, an identifier of said source set top box, and identifier of a destination set top box, and a packet header information;
multiplexing means in communication with said packetizing means for multiplexing said plurality of data packets and audio data and video data into an output transport stream; and
broadcasting means in communication with said multiplexing means for broadcasting said output transport stream to a destination set top box.

30. The communication system of claim 29, wherein said transmitting is done via telephone or cable.

31. The communication system of claim 29, wherein said broadcasting is done via satellite, cable, or wireless.
